(19) United States
(12) Patent Application Publication
(10) Pub. No.: US 2011/0256836 A1
(43) Pub. Date: Oct. 20, 2011

(54) RADIO BASE STATION APPARATUS AND MOBILE TERMINAL APPARATUS

(75) Inventors: Nobuhiko Miki, Kanagawa (JP); Yoshihisa Kishiyama, Kanagawa (JP)

(73) Assignee: NTT DOCOMO, INC., Tokyo (JP)

(21) Appl. No.: 13/126,702

(22) PCT Filed: Oct. 29, 2009
(86) PCT No.: PCT/JP2009/068589

§ 371 Date: Jun. 28, 2011

(30) Foreign Application Priority Data
Nov. 4, 2008 (JP) 2008-283755

(51) Int. Cl. H04B 1/00

(52) U.S. Cl. 455/68

(57) ABSTRACT

The present invention provides a radio base station apparatus and a mobile terminal apparatus that can realize efficient reception control when a plurality of mobile communication systems coexist. The radio base station apparatus allocates a control signal of the mobile communication system having a relatively wide system band composed of component carriers to at least two component carriers in a decoding unit composed of a plurality of data blocks, the mobile terminal apparatus corresponding to the mobile communication system receives the control signal, the mobile terminal apparatus demodulates the control signal in a decoding unit composed of a plurality of data blocks and determines whether or not the control signal is directed to the mobile terminal apparatus.

### TECHNICAL FIELD

The present invention relates to a radio base station apparatus and a mobile terminal apparatus in a next-generation mobile communication system.

### BACKGROUND ART

In a UMTS (Universal Mobile Telecommunications System) network, there is an effort underway to extract features of a system based on W-CDMA (Wideband Code Division Multiple Access) to a maximum by adopting HSDPA (High Speed Downlink Packet Access) or HSUPA (High Speed Uplink Packet Access) in order to improve frequency utilization efficiency and improve data rates. In such a UMTS network, Long Term Evolution (LTE) is under study aiming at realization of higher data rates and lower delays. As a multiplexing scheme, LTE uses OFDMA (Orthogonal Frequency Division Multiple Access) which is different from W-CDMA for a downlink and uses SC-FDMA (Single Carrier Frequency Division Multiple Access) for an uplink.

In an LTE system, upon receiving a signal from a radio base station apparatus, a mobile terminal apparatus demodulates a control signal directed to the mobile terminal apparatus and performs control using scheduling information and transmission power control information included in the control signal. In this case, the mobile terminal apparatus demaps a signal mapped to a frequency domain within a range of system band of each system, demodulates the demapped signal and determines whether or not the control signal is directed to the mobile terminal apparatus (blind decoding). The mobile terminal apparatus then transmits/receives a shared data channel signal according to radio resource allocation information included in the control signal directed to the mobile terminal apparatus. As shown in FIG. 7, in blind decoding, CCEs (Control Channel Elements), which are data blocks in one sub frame, are decoded one by one and subjected to CRC (Cyclic Redundancy Check) to determine whether or not the control signal is directed to the mobile terminal apparatus. In FIG. 7, CCE#3 is a control signal directed to the mobile terminal apparatus and decoding CCE#3 makes it possible to acquire radio resource allocation information corresponding to a user ID (Non-Patent Document 1 to Non-Patent Document 3).

### CITATION LIST

### Non-Patent Literature

Non-Patent Literature 1: 3GPP, TS 36.211 (V.8.4.0), “Evolved Universal Terrestrial Radio Access (E-UTRA); Physical Channels and Modulation (Release 8)”. September 2008
Non-Patent Literature 2: 3GPP, TS 36.212 (V.8.4.0), “Evolved Universal Terrestrial Radio Access (E-UTRA); Multiplexing and channel coding (Release 8)”, September 2008
Non-Patent Literature 3: 3GPP, TS 36.213 (V.8.4.0), “Evolved Universal Terrestrial Radio Access (E-UTRA); Physical layer procedures (Release 8)”, September 2008

### SUMMARY OF INVENTION

### Technical Problem

The third-generation system can generally realize a transmission rate on the order of maximum 2 Mbps on a downlink using a fixed band of 5 MHz. On the other hand, the LTE system can realize a transmission rate such as maximum 300 Mbps on a downlink and on the order of 75 Mbps on an uplink using a variable band of 1.4 MHz to 20 MHz. Furthermore, regarding the UMTS network, there are also studies on a system that will be a successor of LTE aiming at achieving a broader band and speed enhancement (e.g., LTE Advanced (LTE-A)). Therefore, it can be expected that a plurality of such mobile communication systems will coexist and a configuration compatible with such a plurality of systems (radio base station apparatuses and mobile terminal apparatuses or the like) will be required in the future.

Assuming a system band of the LTE system as one unit (component carrier: CC), the LTE-A system performs radio communication using a system band including a plurality of component carriers. In such an LTE-A system, since the system band includes a plurality of component carriers, a control signal may be allocated to a plurality of component carriers. When a control signal is allocated to a plurality of component carriers in this way, the number of times decoding is performed increases extremely during the aforementioned blind decoding. That is, as shown in FIG. 8, when the LTE-A system has a system band for two component carriers, a control signal may be allocated to one of 12 CCEs of CCE#2 to CCE#7 of CC#1 and CCE#2 to CCE#7 of CC#2 and if one CCE is assumed to be a decoding unit as in the case of blind decoding of the LTE system, blind decoding needs to be performed a maximum of 12 times, taking a considerably long processing time, making it impossible to perform reception control speedily. Therefore, there is a demand for a scheme capable of realizing efficient reception control, compatible with a plurality of mobile communication systems (LTE system and LTE-A system).

The present invention has been implemented in view of the above described aspects and it is an object of the present invention to provide a radio base station apparatus and a mobile terminal apparatus capable of realizing efficient reception control even when a plurality of mobile communication systems coexist.

### Solution to the Problem

A radio base station apparatus of the present invention includes control signal generating section configured to generate a control signal of a mobile communication system having a relatively wide system band composed of component carriers and control signal allocating section configured to allocate the control signal of the mobile communication system to at least two component carriers by a decoding unit composed of a plurality of data blocks.

A mobile terminal apparatus of the present invention includes receiving section configured to receive a control signal of a mobile communication system having a relatively wide system band composed of component carriers and demodulating section configured to decode the control signal by a decoding unit composed of a plurality of data blocks and determine whether or not the control signal is directed to the mobile terminal apparatus.

### Technical Advantage of Invention

In the present invention, the radio base station apparatus allocates a control signal of a mobile communication system having a relatively wide system band composed of component carriers to at least two component carriers by a decoding unit composed of a plurality of data blocks, the mobile terminal apparatus corresponding to the mobile communication system receives the control signal, the mobile terminal apparatus demodulates the control signal by a decoding unit composed of a plurality of data blocks and determines whether or not the control signal is directed to the mobile terminal apparatus, and therefore it is possible to realize efficient reception control in a situation in which a plurality of mobile communication systems coexist.

### BRIEF DESCRIPTION OF DRAWINGS

FIG. 1 is a diagram illustrating a frequency usage state when mobile communication is performed on a downlink;

FIG. 2 is a diagram illustrating a schematic configuration of a radio base station apparatus according to an embodiment of the present invention;

FIG. 3 is a diagram illustrating a system band of an LTE system;

FIG. 4 is a diagram illustrating a case where a control signal is allocated over at least two CCs using a decoding unit composed of a plurality of data blocks (CCE);

FIG. 5 is a diagram illustrating another example of the case where a control signal is allocated over at least two CCs using a decoding unit composed of a plurality of data blocks (CCE);

FIG. 6 is a diagram illustrating a schematic configuration of a mobile terminal apparatus according to the embodiment of the present invention;

FIG. 7 is a diagram illustrating blind decoding in the LTE system; and

FIG. 8 is a diagram illustrating blind decoding in the LTE system.

### DESCRIPTION OF EMBODIMENTS

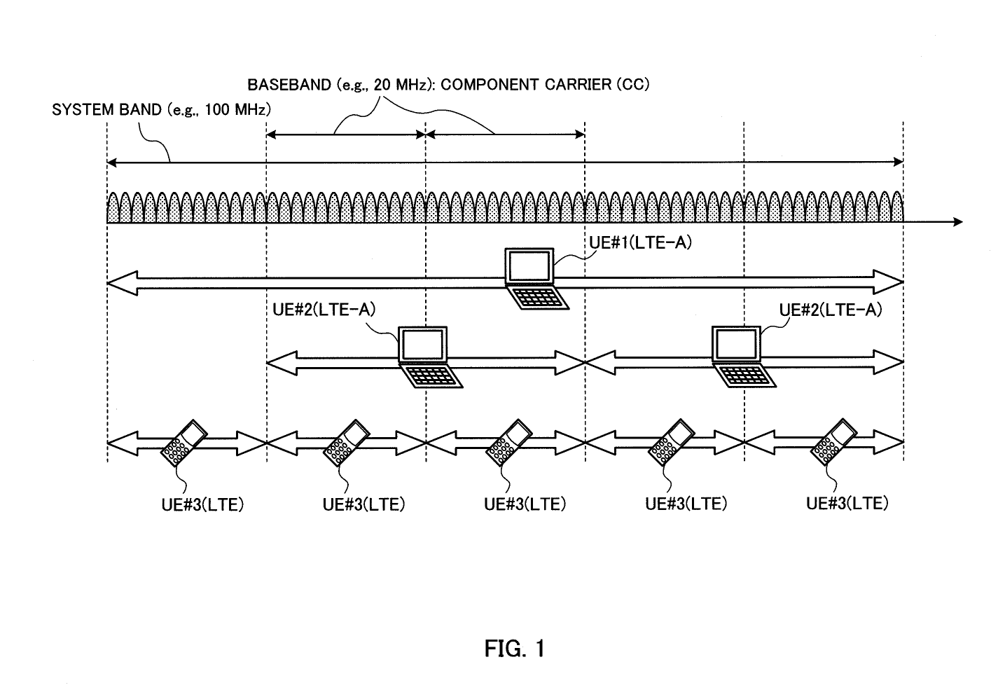

Hereinafter, an embodiment of the present invention will be described in detail with reference to the accompanying drawings. FIG. 1 is a diagram illustrating a frequency usage state when mobile communication is performed on a downlink. The example shown in FIG. 1 is a frequency usage state when an LTE-A system which is a first mobile communication system having a relatively wide first system band composed of a plurality of component carriers and an LTE system which is a second mobile communication system having a relatively narrow (here, composed of one component carrier) second system band coexist. The LTE-A system performs radio communication using a variable system bandwidth of, for example, 100 MHz or less, while the LTE system performs radio communication using a variable system bandwidth of 20 MHz or less. The system band of the LTE-A system is composed of at least one fundamental frequency domain (component carrier: CC) using the system band of the LTE system as one unit. Uniting a plurality of fundamental frequency domains into one wider band is referred to as “carrier aggregation.”

For example, in FIG. 1, the system band of the LTE-A system is composed of a system band (20 MHz×5=100 MHz) including a band of five component carriers assuming the system band of the LTE system (baseband: 20 MHz) as one component carrier. In FIG. 1, a mobile terminal apparatus UE (User Equipment) #1 is an LTE-A system compatible mobile terminal apparatus (also compatible with the LTE system) and has a system band of 100 MHz, a UE#2 is an LTE-A system compatible mobile terminal apparatus (compatible with the LTE system) and has a system band of 40 MHz (20 MHz×2=40 MHz) and a UE#3 is a mobile terminal apparatus compatible with the LTE system (not compatible with the LTE-A system) and has a system band of 20 MHz (baseband).

The present applicant has already applied for a patent on such an invention that divides the system band of the LTE-A system so as to be a system band including at least one frequency band assuming the system band of the LTE system as one unit (Japanese Patent Application No. 2008-88103). As for the LTE-A system, it is not necessary to perform mobile communication with all mobile terminal apparatuses using a band of 100 MHz and there can be mobile terminal apparatuses that perform mobile communication using another system band of 100 MHz or less, for example, a band of 40 MHz.

Since the LTE-A system and LTE system use OFDMA on downlinks, transmission is performed by mapping a transmission signal to a frequency domain within a range of the system band. Therefore, mapping is performed in a frequency domain having a bandwidth of 100 MHz or less (five component carriers) in the LTE-A system and mapping is performed in a frequency domain having a bandwidth of 20 MHz or less (one component carrier) in the LTE system. In the LTE system, control signals are mapped to first one to three OFDM symbols (IFFT (Inverse Fast Fourier Transform) unit). Thus, in the LTE-A system, since the system band includes a plurality of component carriers, control signals are allocated to a plurality of component carriers.

The present inventor et al. came up with the present invention in order to realize efficient reception control focusing on the above described points. That is, the essence of the present invention is to realize efficient reception control when a plurality of mobile communication systems coexist by a radio base station apparatus allocating a control signal of a mobile communication system having a relatively wide system band which is composed of component carriers to at least two component carriers in a decoding unit composed of a plurality of data blocks, a mobile terminal apparatus corresponding to the mobile communication system receiving the control signal, and the mobile terminal apparatus demodulating the control signal by a decoding unit composed of a plurality of data blocks and determining whether or not the control signal is directed to the mobile terminal apparatus.

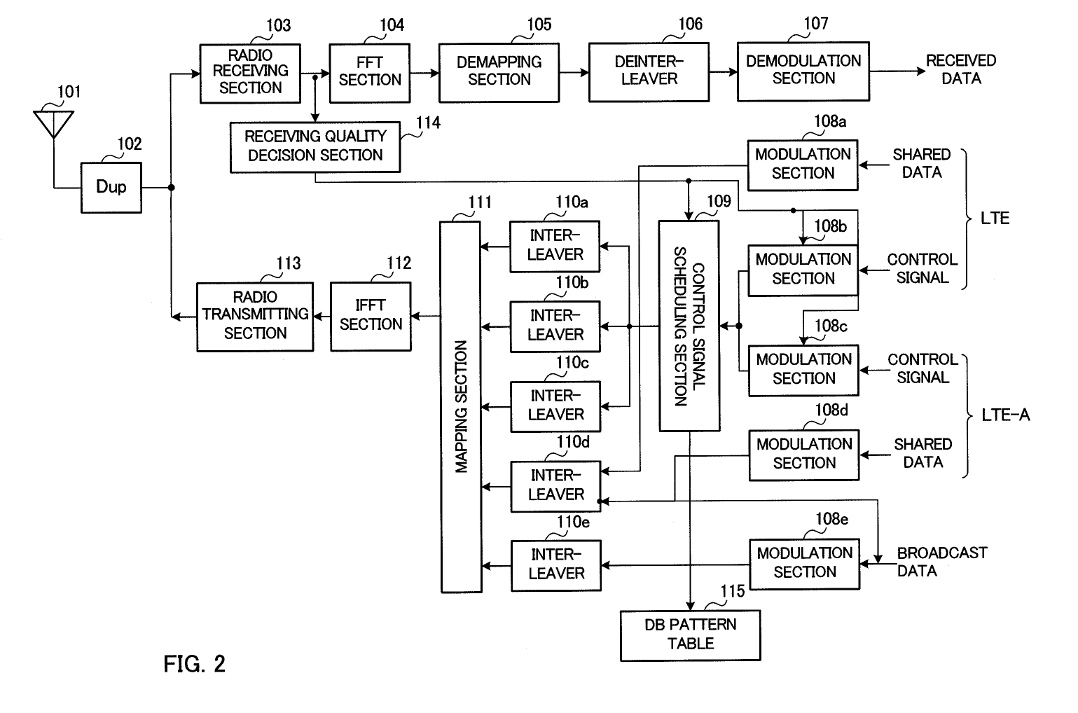

FIG. 2 is a block diagram illustrating a configuration of a radio base station apparatus according to an embodiment of the present invention. The radio base station apparatus shown in FIG. 2 is mainly comprised of a transmitting/receiving antenna 101, a duplexer 102, a receiving system processing section and a transmitting system processing section.

The receiving system processing section is mainly comprised of a radio receiving section 103 that performs predetermined reception processing on a signal sent from a mobile terminal apparatus, an FFT section 104 that performs FFT (Fast Fourier Transform) calculation on the received signal, a demapping section 105 that demaps the signal after the FFT calculation, a deinterleaver 106 that deinterleaves the demapped signal and a demodulation section 107 that demodulates the deinterleaved signal and obtains received data. Furthermore, the receiving system processing section also includes a receiving quality deciding section 114 that measures quality of the received signal and decides whether a propagation environment is good or bad based on the measurement result. The receiving system processing section exists in each mobile terminal apparatus, but for simplicity of drawings, FIG. 2 shows only a configuration corresponding to one mobile terminal apparatus.

The transmitting system processing section is mainly comprised of modulation sections 108a to 108e that modulate data to be transmitted to the mobile terminal apparatus into a modulated signal, a control signal scheduling section 109 that is control signal allocating means for allocating a modulated signal of a control signal to a predetermined frequency domain, interleavers 110a to 110e that interleave the signal allocated to the predetermined frequency domain, a mapping section 111 that maps the interleaved signals to the time/frequency domain, an IFFT section 112 that applies IFFT (Inverse Fast Fourier Transform) calculation to the mapped signal, a radio transmitting section 113 that performs predetermined transmission processing to the signal after the IFFT calculation and a data block pattern table (DB pattern table) 115 that stores predetermined data block patterns that for at least two component carriers.

The radio receiving section 103 of the receiving system processing section obtains a baseband signal by performing gain control on the received signal first. Next, the baseband signal is subjected to quadrature detection processing, got rid of unnecessary frequency components and then A/D-converted. The A/D-converted signal is outputted to the FFT section 104 and also outputted to the receiving quality deciding section 114. The receiving quality deciding section 114 measures receiving quality of the baseband signal (such as receiving power, SIR (Signal Interference Ratio)) and decides whether or not the propagation environment with the mobile terminal apparatus is good or bad based on the measurement result. For example, the receiving quality deciding section 114 performs a threshold decision on the measured value of the receiving quality and decides whether the propagation environment with the mobile terminal apparatus is good or bad based on the decision result. The quality decision result of the propagation environment is outputted to the modulation sections 108b and 108c and/or control signal scheduling section 109.

The FFT section 104 performs FFT calculation on the baseband signal from each mobile terminal apparatus outputted from the radio receiving section 103 and obtains a signal allocated to each subcarrier. The signal is outputted to the demapping section 105. The demapping section 105 performs demapping on the signal obtained according to a mapping rule on the mobile terminal apparatus side. The demapped signal is outputted to the deinterleaver 106 per mobile terminal apparatus. The deinterleaver 106 deinterleaves the demapped signal. The deinterleaved signal is outputted to the demodulation section 107 per mobile terminal apparatus. The demodulation section 107 demodulates the deinterleaved signal and obtains received data of each mobile terminal apparatus.

The modulation sections 108a to 108e of the transmitting system processing section digitally modulate the transmission data into modulated signals according to a predetermined modulation scheme. The modulation section 108a modulates shared data for an LTE system mobile terminal apparatus. The modulation section 108b modulates a control signal for an LTE system mobile terminal apparatus. The modulation section 108c modulates a control signal for an LTE-A system mobile terminal apparatus. The modulation section 108d modulates shared data for an LTE-A system mobile terminal apparatus. The modulation section 108e modulates information (broadcast data) broadcast by a broadcast channel. The modulated signal of the shared data is outputted to the interleaver 110d. The modulated signal of the control signal is outputted to the control signal scheduling section 109 and the scheduled control signal is outputted to the interleavers 110a to 110c. The modulated signal of the broadcast data is outputted to the interleaver 110e. The broadcast data includes data block pattern information or the like when using a data block pattern which will be described later. The modulation sections 108b and 108c may change the modulation scheme based on the decision result in the receiving quality deciding section 114. For example, a modulation scheme having a relatively low rate may be adopted for a frequency domain where the propagation environment is poor.

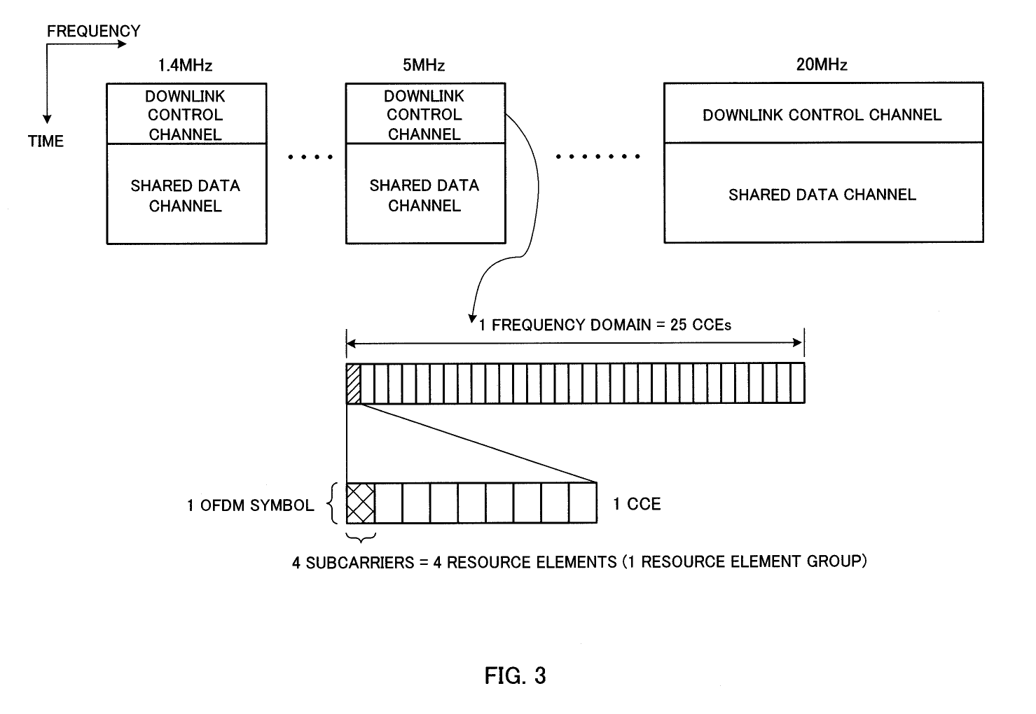

Here, a system band to which a control signal of a downlink signal transmitted from the radio base station apparatus to the mobile terminal apparatus is allocated will be described. FIG. 3 is a diagram illustrating a system band of the LTE system. As is clear from FIG. 3, the LTE system uses various system bands (1.4 MHz, 5 MHz, 20 MHz in FIG. 3) which is equal to or below 20 MHz. The system band is determined for each frequency or cell as appropriate. In this system band, mobile communication is performed using a downlink control channel and a shared data channel.

A control signal of a downlink control channel is distributed among a plurality of data blocks (here, 25 data blocks (CCE: Control Channel Elements)) as shown in FIG. 3 and one data block (1 CCE) corresponds to 36 subcarriers ×1 OFDM symbol. 1 subcarrier ×1 OFDM symbol is referred to as “resource element (RE)” and four resource elements are referred to as one “resource element group (REG).” This data block configuration is the same even when the system band is different. That is, the control signal is distributed among CCEs and CCE is allocated to the system band. On the other hand, in the LTE-A system, the control signal is also distributed among CCEs in the same way as in the LTE system and CCE is allocated to a frequency domain equal to or below 100 MHz which is the system band. Therefore, referring to FIG. 1, the control signal corresponding to the mobile terminal apparatus UE#1 is distributed among CCEs, this CCE is allocated to 100 MHz which is the system band and the control signal corresponding to the mobile terminal apparatus UE#2 is distributed among CCEs, this CCE is allocated to 40 MHz which is the system band, and the control signal corresponding to the mobile terminal apparatus UE#3 is distributed among CCEs and this CCE is allocated to 20 MHz which is the system band. The system band to which a CCE is allocated constitutes the channel coding unit.

The control signal scheduling section 109 allocates radio resources for transmitting/receiving a shared data channel signal and allocates a control signal to at least two CCs by a decoding unit composed of a plurality of data blocks (CCE). For example, the control signal is allocated by a decoding unit composed of a plurality of data blocks (CCE) to at least two CCs when 20 MHz which is the maximum system band of the LTE system is assumed to be one unit (CC).

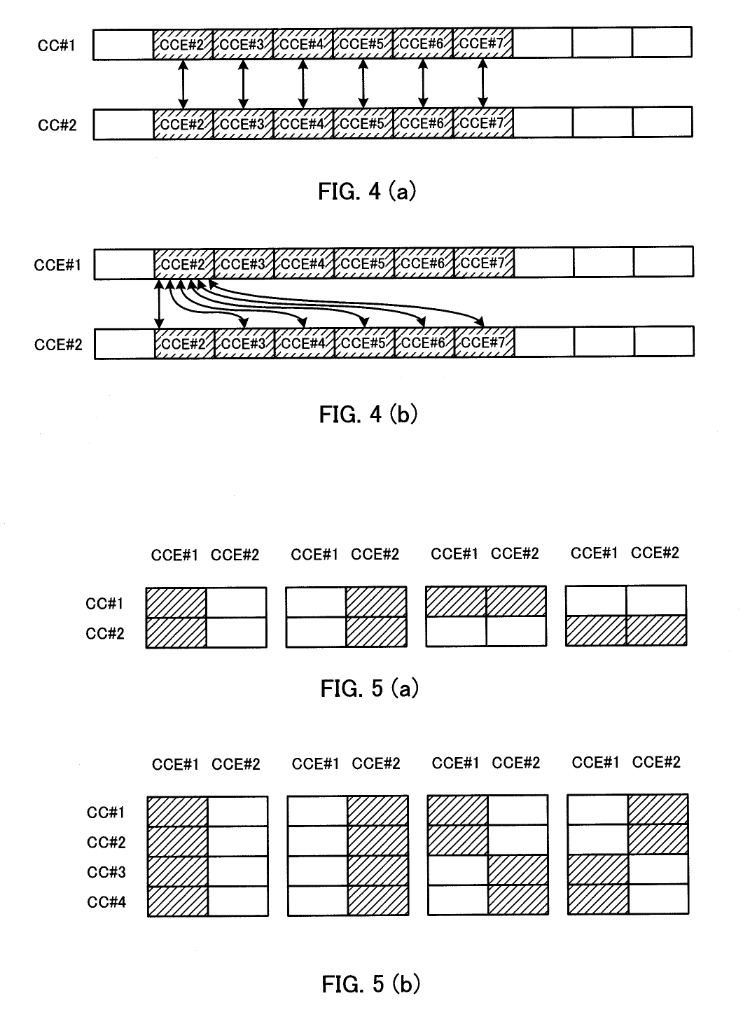

FIGS. 4(a) and (b) are diagrams illustrating a case where a control signal is allocated over at least two CCs by a decoding unit composed of a plurality of data blocks (CCE). Here, a case will be described where a control signal is allocated over two CCs; CC#1 and CC#2 using 20 MHz which is a maximum system band of the LTE system as one unit.

In the allocation mode shown in FIG. 4(a), a control signal to be transmitted to a specific mobile terminal apparatus is allocated over two CCs in matching data block (CCE) number in each CC as a decoding unit. That is, in FIG. 4(a), CCE#2 of CC#1 and CCE#2 of CC#2 make up a decoding unit, CCE#3 of CC#1 and CCE#3 of CC#2 make up a decoding unit, CCE#4 of CC#1 and CCE#4 of CC#2 make up a decoding unit, CCE#5 of CC#1 and CCE#5 of CC#2 make up a decoding unit, CCE#6 of CC#1 and CCE#6 of CC#2 make up a decoding unit and CCE#7 of CC#1 and CCE#7 of CC#2 make up a decoding unit. In this mode, the number of blind decoding required corresponds to a predetermined number of CCEs regardless of the number of CCs. In the case shown in FIG. 4(a), the number of times blind decoding is performed is a maximum of six from CCE#2 to CCE#7. Although FIG. 4(a) shows a case with two CCs, the present mode is not limited to this, but is likewise applicable to a case where a control signal is allocated over three or more CCs.

In the allocation mode shown in FIG. 4(b), a control signal to be transmitted to a specific mobile terminal apparatus is allocated over two CCs by combining a data block (CCE) in one CC with a data block (CCE) in the other CC as a decoding unit. In this case, a control signal is allocated over two CCs; CC#1 and CC#2 using 20 MHz which is a maximum system band of the LTE system as one unit. For example, in FIG. 4(b), a control signal is allocated over two CCs by combining CCE#2 in CC#1 with one of CCE#2 to CCE#7 in CC#2 as a decoding unit. In this mode, the degree of freedom of a CCE pattern when allocating a control signal to CC increases and the flexibility of control signal allocation improves.

FIG. 5 is a diagram illustrating another example of the case where a control signal is allocated over at least two CCs by a decoding unit composed of a plurality of data blocks (CCE). Here, a case will be described where a control signal is allocated over four CCs; CC#1 to CC#4 using 20 MHz which is a maximum system band of the LTE system as one unit.

In the allocation mode shown in FIG. 5(b), a control signal to be transmitted to a specific mobile terminal apparatus is allocated using a predetermined data block pattern for at least two component carriers as a decoding unit. Examples of the data block pattern include, as shown in FIG. 5(b), a data block pattern (pattern A) where CCE#1 of CC#1, CCE#1 of CC#2, CCE#1 of CC#3 and CCE#1 of CC#4 make up a decoding unit, a data block pattern (pattern B) where CCE#2 of CC#1, CCE#2 of CC#2, CCE#2 of CC#3 and CCE#2 of CC#4 make up a decoding unit, a data block pattern (pattern C) where CCE#1 of CC#1, CCE#1 of CC#2, CCE#2 of CC#3 and CCE#2 of CC#4 make up a decoding unit, and a data block pattern (pattern D) where CCE#2 of CC#1, CCE#2 of CC#2, CCE#1 of CC#3 and CCE#1 of CC#4a make up a decoding unit. Here, pattern A and pattern B are the same as the allocation mode in FIG. 4(a).

The data block patterns are not limited to the patterns shown in FIG. 5(b), but can be configured by combining, for example, the unit patterns shown in FIG. 5(a) (CCE#1 of CC#1-CCE#1 of CC#2, CCE#2 of CC#1-CCE#2 of CC#2, CCE#1 of CC#1-CCE#2 of CC#1, CCE#1 of CC#2-CCE#2 of CC#2).

Such data block patterns are stored in the DB pattern table 115. When allocating a control signal to CCs, the control signal scheduling section 109 selects data block patterns stored in the DB pattern table 115 with reference to the DB pattern table 115 and allocates a control signal to a plurality of CCs according to the data block patterns. The data block patterns selected on the radio base station apparatus side are reported to the mobile terminal apparatus. The reporting method may be, for example, a reporting method using a control channel or shared data channel when communication starts between the radio base station apparatus and the mobile terminal apparatus or a reporting method using a broadcast channel. Furthermore, when identifying a data block pattern, a predetermined data block pattern may also be used instead of referencing the DB pattern table 115.

The modulated signal of the signal and shared data, and broadcast data allocated as described above are outputted to the interleavers 110a to 110e respectively. The interleavers 110a to 110c perform interleaving for each frequency domain #1 to #3. The interleaved signal is outputted to the mapping section 111. The mapping section 111 maps the interleaved signal to the time/frequency domain. The mapped signal is outputted to the IFFT section 112.

The IFFT section 112 performs IFFT calculation on the mapped signal to transform it into an OFDM signal. The OFDM signal is outputted to the radio transmitting section 113. The radio transmitting section 113 adds a CP (cyclic prefix) to the OFDM signal and the OFDM signal is D/Á-converted to become a baseband signal, got rid of an unnecessary component through a low pass filter and amplified by an amplifier to become a transmission signal. The transmission signal is passed through the duplexer 102 and transmitted via the antenna 101.

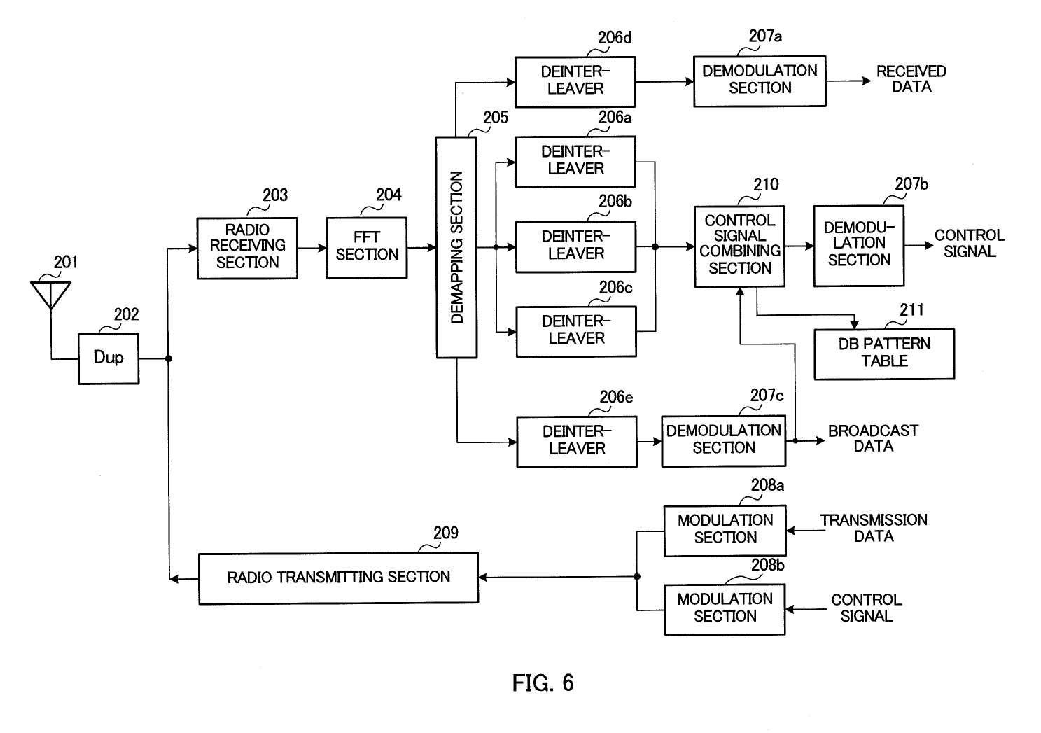

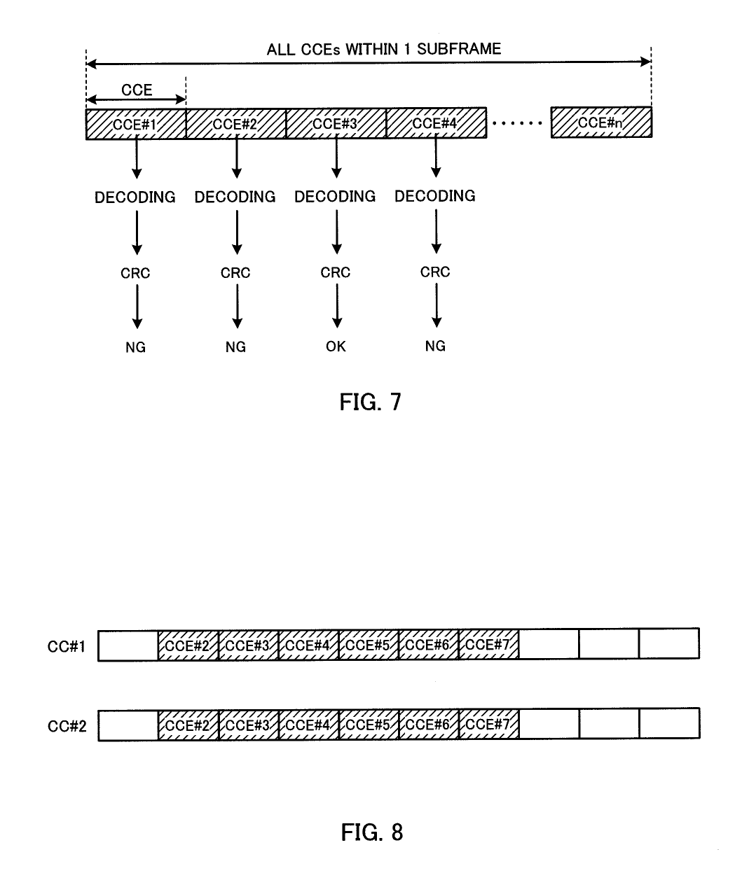

FIG. 6 is a block diagram illustrating a configuration of a mobile terminal apparatus according to the embodiment of the present invention. The mobile terminal apparatus shown in FIG. 6 is a mobile terminal apparatus compatible with an LTE-A system. The mobile terminal apparatus shown in FIG. 6 is mainly comprised of a transmitting/receiving antenna 201, a duplexer 202, a receiving system processing section and a transmitting system processing section.

The receiving system processing section is mainly comprised of a radio receiving section 203 that performs predetermined reception processing on a signal sent from the radio base station apparatus, an FFT section 204 that performs FFT calculation on the received signal, a demapping section 205 that demaps the signal after the FFT calculation, deinterleavers 206a to 206e that deinterleave the demapped signals, demodulation sections 207a to 207c that demodulate the deinterleaved signal and obtain received data, a control signal combining section 210 that combines CCEs allocated to a plurality of CCs and a DB pattern table 211 that stores a data block pattern which is a decoding unit during blind decoding.

The transmitting system processing section is mainly comprised of modulation sections 208a and 208b that modulate data transmitted to the radio base station apparatus into a modulated signal and a radio transmitting section 209 that performs predetermined transmission processing on the modulated signal.

The radio receiving section 203 in the receiving system processing section performs gain control on a received signal and obtains a baseband signal first. Next, this baseband signal is subjected to quadrature detection processing, then got rid of an unnecessary frequency component and then A/D-converted. The A/D-converted signal is outputted to the FFT section 204.

The FFT section 204 performs FFT calculation on the baseband signal from the radio base station apparatus outputted from radio receiving section 203 and obtains a signal allocated to each subcarrier. This signal is outputted to the demapping section 205. The demapping section 205 performs demapping on the signal from the time/frequency domain according to a mapping rule on the radio base station apparatus side. The demapped signal is outputted to the deinterleavers 206a to 206e for each frequency domain. The deinterleavers 206a to 206e deinterleave the demapped signal. The deinterleaved signals are outputted to the demodulation sections 207a and 207c, and the control signal combining section 210. That is, the deinterleaved shared data is outputted to the demodulation section 207a, the deinterleaved control signal is outputted to the control signal combining section 210 and the deinterleaved broadcast data is outputted to the demodulation section 207c.

The demodulation section 207a demodulates the deinterleaved signal into received data (shared data). Furthermore, the demodulation section 207c demodulates the deinterleaved signal into broadcast data.

The deinterleaved control signal is outputted to the control signal combining section 210 and is combined into the decoding unit by the control signal combining section 210. That is, the control signal combining section 210 combines a plurality of data blocks (CCE) as the decoding unit for performing blind decoding. In the case of the allocation mode shown in FIG. 4(a), data blocks of the same number in respective CCs are combined into a decoding unit. For example, as shown in FIG. 4(a), CCE#2 of CC#1 and CCE#2 of CC#2 are combined as a decoding unit, CCE#3 of CC#1 and CCE#3 of CC#2 are combined as a decoding unit, CCE#4 of CC#1 and CCE#4 of CC#2 are combined as a decoding unit, CCE#5 of CC#1 and CCE#5 of CC#2 are combined as a decoding unit, CCE#6 of CC#1 and CCE#6 of CC#2 are combined as a decoding unit and CCE#7 of CC#1 and CCE#7 of CC#2 are combined as a decoding unit.

Furthermore, in the case of the allocation mode shown in FIG. 4(b), regarding a control signal allocated over two CCs, one data block in one CC and one data block in the other CC are combined as a decoding unit. For example, as shown in FIG. 4(b), CCE#2 in CC#1 and CCE#2 to CCE#7 in CC#2 are combined as a decoding unit, CCE#3 in CC#1 and CCE#2 to CCE#7 in CC#2 are combined as a decoding unit, CCE#4 in CC#1 and CCE#2 to CCE#7 in CC#2 are combined as a decoding unit, CCE#5 in CC#1 and CCE#2 to CCE#7 in CC#2 are combined as a decoding unit, CCE#6 in CC#1 and CCE#2 to CCE#7 in CC#2 are combined as a decoding unit, and CCE#7 in CC#1 and CCE#2 to CCE#7 in CC#2 are combined as a decoding unit.

Furthermore, in the case of allocation mode shown in FIG. 5(b), control signals are combined using a data block pattern predetermined on at least two CCs as a decoding unit. For example, as shown in FIG. 5(b), CCE#1 of CC#1, CCE#1 of CC#2, CCE#1 of CC#3 and CCE#1 of CC#4 are combined as a decoding unit, CCE#2 of CC#1, CCE#2 of CC#2, CCE#2 of CC#3 and CCE#2 of CC#4 are combined as a decoding unit, CCE#1 of CC#1, CCE#1 of CC#2, CCE#2 of CC#3 and CCE#2 of CC#4 are combined as a decoding unit, and CCE#2 of CC#1, CCE#2 of CC#2, CCE#1 of CC#3 and CCE#1 of CC#4 are combined as a decoding unit.

In this case, the control signal combining section 210 refers to the DB pattern table 211 based on the data block pattern information, selects a data block pattern corresponding to the data block pattern information and combines the deinterleaved control signals using the data block pattern. Although FIG. 6 describes a case where the data block pattern is reported with broadcast data, the present invention is not limited to this, but the data block pattern may be reported using another signaling method. Furthermore, when the data block pattern is a predetermined data block pattern, the control signals are combined using a predetermined data block pattern without referencing the DB pattern table 211.

Thus, the signal combined by the control signal combining section 210 is outputted to the demodulation section 207b. The demodulation section 207b repeats blind decoding in the combined decoding unit to determine whether or not the control signal is directed to the mobile terminal apparatus. By this means, the mobile terminal apparatus obtains a control signal directed to the mobile terminal apparatus, and can transmit/receive a shared data channel signal according to the radio resource allocation information included in the control signal.

The modulation sections 208a and 208b of the transmitting system processing section digitally modulates the transmission data and control signal into a modulated signal according to a predetermined modulation scheme. The modulated signal is outputted to the radio transmitting section 209. The radio transmitting section 209 applies predetermined transmission processing to the modulated signal. The transmission signal obtained in this way is passed through the duplexer 202 and transmitted via the antenna 201.

Next, examples of the mobile communication system composed of the radio base station apparatus and mobile terminal apparatus according to the embodiment of the present invention will be described.

### Example 1

A case will be described in the present embodiment where an LTE-A system compatible mobile communication terminal performs blind decoding by combining data blocks of the same number in respective CCs as a decoding unit. Here, suppose a control signals is included in CCE#3 of CCE#2 to CCE#7 (CCE#3 of CC#1 and CCE#3 of CC#2).

First, in the radio base station apparatus, the modulation section 108c modulates an LTE-A system control signal into a modulated signal. The modulated signal is outputted to the control signal scheduling section 109. The control signal scheduling section 109 allocates the LTE-A system control signal to CCE#3 over CC#1 and #2. The allocated control signals are outputted to the interleavers 110a and 110b. Furthermore, in the radio base station apparatus, the modulation section 108d modulates the LTE-A system shared data into a modulated signal. The modulated signal is outputted to the interleaver 110d.

The interleaver 110a interleaves the control signal allocated to CC#1 and the interleaved control signal is outputted to the mapping section 111. The interleaver 110b interleaves the control signal allocated to CC#2 and the interleaved control signal is outputted to the mapping section 111. The interleaved control signal is outputted to the mapping section 111. The interleaver 110d interleaves the shared data and the interleaved signal is outputted to the mapping section 111. The interleaver 110e interleaves the broadcast data and the interleaved signal is outputted to the mapping section 111.

The mapping section 111 maps the interleaved signal to the time/frequency domain. The mapped signal is outputted to the IFFT section 112. The IFFT section 112 performs IFFT calculation on the mapped signal to transform it into an OFDM signal. The OFDM signal is outputted to the radio transmitting section 113, subjected to the aforementioned predetermined transmission processing and becomes a transmission signal. The transmission signal is passed through the duplexer 102 and transmitted via the antenna 101.

In an LTE-A system compatible mobile terminal apparatus, the radio receiving section 203 performs the aforementioned predetermined reception processing on a received signal into a baseband signal. The baseband signal is outputted to the FFT section 204, subjected to FFT calculation and a signal allocated to each subcarrier is thereby obtained. The signal is outputted to the demapping section 205. The demapping section 205 performs demapping on the signal obtained according to a mapping rule on the radio base station apparatus side from the time/frequency domain. The demapped signal is outputted to the deinterleavers 206a, 206b, 206d and 206e of CC#1 and CC#2 where the demapped signal is deinterleaved. The deinterleaved shared data is outputted to the demodulation section 207a and the deinterleaved broadcast data is outputted to 207c and the deinterleaved control signal is outputted to the control signal combining section 210.

The demodulation section 207a demodulates the deinterleaved signal into received data (shared data) and the demodulation section 207c demodulates the deinterleaved signal into broadcast data.

As shown in FIG. 4(a), the control signal combining section 210 combines CCE#2 of CC#1 and CCE#2 of CC#2 as a decoding unit and outputs the combined control signal to the demodulation section 207b. The demodulation section 207b demodulates the combined control signal as a decoding unit (CCE#2 of CC#1 and CCE#2 of CC#2), performs CRC and determines whether or not the control signal is obtained as a control signal directed to the mobile terminal apparatus. Here, the control signal directed to the mobile terminal apparatus is not obtained. Next, control signal combining section 210 combines CCE#3 of CC#1 and CCE#3 of CC#2 as a decoding unit and outputs the combined control signal to the demodulation section 207b. The demodulation section 207b demodulates the control signal combined as a decoding unit (CCE#3 of CC#1 and CCE#3 of CC#2), performs CRC and determines whether or not the control signal is obtained as a control signal directed to the mobile terminal apparatus. Here, a control signal directed to the mobile terminal apparatus is obtained. Shared data is processed using this control signal.

Thus, in the present example, blind decoding is performed using data blocks of the same number in each CC as the decoding unit, and it is thereby possible to reduce the number of times blind decoding is performed (here, maximum six times) and realize efficient reception control.

### Example 2

The present example will describe a case where an LTE-A system compatible mobile communication terminal performs blind decoding using a predetermined data block pattern for at least two CCs as a decoding unit. Here, suppose control signals are included in CCE#1 of CC#1, CCE#1 of CC#2, CCE#2 of CC#3 and CCE#2 of CC#4.

Broadcast data, shared data and control signal are transmitted from the radio base station apparatus to the mobile terminal apparatus in the same way as in Example 1 except that control signals in the LTE-A system in the control signal scheduling section 109 are allocated to CCE#1 of CC#1, CCE#1 of CC#2, CCE#2 of CC#3 and CCE#2 of CC#4.

The LTE-A system compatible mobile terminal apparatus performs predetermined reception processing, FFT calculation, demapping and deinterleaving on a received signal in the same way as in Example 1 and outputs the deinterleaved signal to the demodulation sections 207a and 207c and control signal combining section 210. The demodulation section 207a demodulates the deinterleaved signal into received data (shared data) and the demodulation section 207c demodulates the deinterleaved signal into broadcast data.

As shown in FIG. 5(b), the control signal combining section 210 combines CCE#1 of CC#1, CCE#1 of CC#2, CCE#2 of CC#3 and CCE#2 of CC#4 as a decoding unit and outputs the combined control signal to the demodulation section 207b. The demodulation section 207b demodulates the control signals combined as a decoding unit (CCE#1 of CC#1, CCE#1 of CC#2, CCE#2 of CC#3 and CCE#2 of CC#4), performs CRC and determines whether or not the control signal is obtained as a control signal directed to the mobile terminal apparatus. Here, a control signal directed to the mobile terminal apparatus is obtained. Shared data is processed using the control signal. The data block pattern which is the decoding unit is acquired by a broadcast channel (BCH) broadcast by the radio base station apparatus.

Thus, in the present example, blind decoding is performed using data blocks of the same number in each CC as the decoding unit, and it is thereby possible to reduce the number of times blind decoding is performed (here once) and realize efficient reception control.

The present invention is not limited to the above described embodiment, but can be implemented modified in various ways. For example, although the above embodiment describes a case where the transmitting side interleaves and transmits shared data and the receiving side interleaves the shared data, the present invention is not limited to this, but is applicable to a case where shared data is not interleaved likewise. Furthermore, the data block allocation pattern, number of processing sections, processing procedure, number of component carriers and number of data blocks, data block range in the above descriptions can be implemented modified as appropriate without departing from the scope of the present invention. In addition, the present invention can be implemented modified as appropriate without departing from the scope of the present invention.

1. A radio base station apparatus comprising:
control signal generating section configured to generate a control signal of a mobile communication system having a relatively wide system band composed of component carriers; and
control signal allocating section configured to allocate the control signal of the mobile communication system to at least two component carriers by a decoding unit composed of data blocks.

2. The radio base station apparatus according to claim 1, wherein the control signal allocating section allocates control signals to be transmitted to a specific mobile terminal apparatus to the component carriers in matching data block number in respective component carriers as a decoding unit.

3. The radio base station apparatus according to claim 1, wherein the control signal allocating section allocates a control signal to be transmitted to a specific mobile terminal apparatus to the component carriers in a predetermined data block pattern for at least two component carriers as a decoding unit.

4. A mobile terminal apparatus comprising:
receiving section configured to receive a control signal of a mobile communication system having a relatively wide system band composed of component carriers; and
demodulating section configured to decode the control signal by a decoding unit composed of a plurality of data blocks and determine whether or not the control signal is directed to the mobile terminal apparatus.

5. The mobile terminal apparatus according to claim 4, wherein the demodulating section performs decoding by combining data blocks of the same number in respective component carriers as a decoding unit and determines whether or not the control signal is directed to the mobile terminal apparatus.

6. The mobile terminal apparatus according to claim 4, wherein the demodulating section decodes a predetermined data block pattern extending over at least two component carriers as a decoding unit and determines whether or not the control signal is directed to the mobile terminal apparatus.

7. The mobile terminal apparatus according to claim 4, wherein the demodulating section combines one data block in one component carrier with a data block of another component carrier as a decoding unit for a control signal allocated over two component carriers and determines whether or not the control signal is directed to the mobile terminal apparatus.

8. A radio communication method comprising the steps of:
allocating, by a radio base station apparatus, a control signal of a mobile communication system having a relatively wide system band composed of component carriers to at least two component carriers in a decoding unit composed of a plurality of data blocks;
receiving the control signal in a mobile terminal apparatus supporting to the mobile communication system; and
decoding, by the mobile terminal apparatus, the control signal in a decoding unit composed of a plurality of data blocks and determining whether or not the control signal is directed to the mobile terminal apparatus.

9. The radio communication method according to claim 8, wherein the radio base station apparatus allocates a control signal to be transmitted to a specific mobile terminal apparatus in matching data block number in respective component carriers as a decoding unit, and
the mobile terminal apparatus performs decoding by combining the data blocks of the same number as a decoding unit and determines whether or not the control signal is directed to the mobile terminal apparatus.

10. The radio communication method according to claim 8, wherein radio base station apparatus allocates a control signal to be transmitted to a specific mobile terminal apparatus in a predetermined data block pattern for at least two component carriers as a decoding unit, and
the mobile terminal apparatus performs decoding using the data block pattern as a decoding unit and determines whether or not the control signal is directed to the mobile terminal apparatus.
